(19) United States
(12) Patent Application Publication
(10) Pub. No.: US 2011/0135100 A1
(43) Pub. Date: Jun. 9, 2011

(54) Loudspeaker Array Device and Method for Driving the Device

(75) Inventor: Wuzhou Zhan, Shenzhen (CN)

(73) Assignee: Huawei Device Co., LTD, Shenzhen (CN)

(21) Appl. No.: 13/016,462

(22) Filed: Jan. 28, 2011

Related U.S. Application Data
(63) Continuation of application No. PCT/CN2009/072580, filed on Jul. 1, 2009.

(30) Foreign Application Priority Data
Jul. 28, 2008 (CN) 200810117294.0

(51) Int. Cl. H04R 5/00

(52) U.S. Cl. 381/17

(57) ABSTRACT

A loudspeaker array device and a method for driving the device are disclosed. The device includes: a delay module, a gain module, and a parameter calculating module. The parameter calculating module includes: a controlling module, configured to determine, according to received user control information, types of delay parameters and gain parameters that need to be calculated, and output a determination result; and a calculation executing module, configured to calculate and output the delay parameters and the gain parameters according to the determination result output by the controlling module. The delay module is configured to process and output audio signals according to the received delay parameters. The gain module is configured to process and output audio signals according to the received gain parameters. According to the present invention, the loudspeaker array device implements not only sound source reproduction and but also sound focus. The implementation is simple, convenient, and cost effective.

This application is a continuation of co-pending International Application No. PCT/CN2009/072580, filed on Jul. 1, 2009, which designated the United States and was not published in English, and which claims priority to Chinese Application No. 200810117294.0, filed on Jul. 28, 2008, both of which applications are incorporated herein by reference.

### TECHNICAL FIELD

The present invention relates to an electronic technology, and in particular, to a loudspeaker array device and a method for driving the device.

### BACKGROUND

At present, the loudspeaker array technology is widely used in the field of sound reproduction. This technology has various applications. Two typical applications are sound source reproduction and sound focus.

When the sound is played, the sound source reproduction is to reproduce the space information of the original sound source (including the horizontal angle, vertical angle, and distance), which can be implemented through wave field synthesis. The wave filed synthesis uses Huyghen (a sound wave synthesis technology) to implement sound synthesis. The basic principle of Huyghen is as follows: One original wave source emits sound waves in the manner of a sphere. The transmission times from the original wave source to the points on the sphere are the same. The sphere is called a wave front, on which all the points may be regarded as new wave sources. These wave sources and the original wave source have the same rate and wavelength. The waves emitted by these wave sources form a new wave front in a next instant after the waves are overlapped. The new wave front and the wave front generated by the original wave source are the same. Therefore, the audience may fall into the illusion that the new wave front is generated by the original wave source. The new wave front is the virtual wave source that has the same position as the original wave source.

The sound focus is to focus the sound of each loudspeaker to a position close to the audiences in the playing process so that the sound can be heard only in the position.

During the implementation of the present invention, the inventor finds that the existing loudspeaker array implements merely the sound source reproduction or merely the sound focus, because the implementation of sound focus is reverse to that of sound source reproduction.

### SUMMARY OF THE INVENTION

Embodiments of the present invention provide a loudspeaker array device and a method for driving the device, which can implement both sound source reproduction and sound focus.

Embodiments of the present invention are implemented through the following technical solution.

One embodiment of the present invention provides a loudspeaker array device. The device includes a delay module, a gain module, and a parameter calculating module. The parameter calculating module includes a controlling module that is configured to determine, according to received user control information, types of delay parameters and gain parameters that need to be calculated, and output a determination result, where the parameters include a first delay parameter and a first gain parameter; or a second delay parameter and a second gain parameter; or a first delay parameter, a first gain parameter, a second delay parameter and a second gain parameter. The first delay parameter and the first gain parameter are used to reproduce a sound source, and the second delay parameter and the second gain parameter are used to focus sounds. The parameter calculating module also includes a calculation executing module that is configured to calculate and output the delay parameters and the gain parameters according to the determination result output by the controlling module.

The delay module is configured to process and output audio signals according to the received delay parameters.

The gain module is configured to process and output audio signals according to the received gain parameters.

One embodiment of the present invention provides a method for driving a loudspeaker array device. The method includes:

determining, according to received user control information, delay parameters and gain parameters that need to be calculated, where the parameters include: a first delay parameter and a first gain parameter; or a second delay parameter and a second gain parameter; or a first delay parameter, a first gain parameter, a second delay parameter and a second gain parameter. The first delay parameter and the first gain parameter are used to reproduce a sound source, the second delay parameter and the second gain parameter are used to focus sounds;

calculating the delay parameters and the gain parameters according to the determined the delay parameters and gain parameters that need to be calculated; and

processing and outputting audio signals according to the calculated delay parameters and gain parameters.

It can be seen from the technical solution of the present invention that, in the embodiments of the present invention, the parameter calculating module calculates the delay parameters and the gain parameters according to the received user control information; the delay module and the gain module process the audio signals according to the received delay parameters and gain parameters so that the loudspeaker not only reproduces the sound source but also focuses the sound. The implementation is simple, convenient, and cost effective.

### BRIEF DESCRIPTION OF THE DRAWINGS

FIG. 1 is a structural view of a loudspeaker array device according to one embodiment of the present invention;

FIG. 2 is a schematic diagram of calculating delay parameters in the implementation of sound source reproduction according to one embodiment of the present invention;

FIG. 3 is a schematic diagram of calculating delay parameters in the implementation of sound focus according to one embodiment of the present invention;

FIG. 4 is a structural view of a loudspeaker array device according to another embodiment of the present invention;

FIG. 5 is a structural view of a loudspeaker array device according to another embodiment of the present invention;

FIG. 6 is a flowchart of a method according to one embodiment of the present invention; and

FIG. 7 is a flowchart of a method according to another embodiment of the present invention.

### DETAILED DESCRIPTION OF ILLUSTRATIVE EMBODIMENTS

The embodiments of the present invention meet the requirement of implementing both sound source reproduction and sound focus. For example, when a user is watching TV, the user needs the sound source reproduction; that is, the direction where the sound comes is consistent with the position of the sound source in TV. One example is that, when a person on the left screen is speaking, the sound comes from the left loudspeaker; and when a person on the right screen is speaking, the sound comes from the right loudspeaker. At night, this type of loudspeaker array device implements the sound focus function, which does not disturb other people.

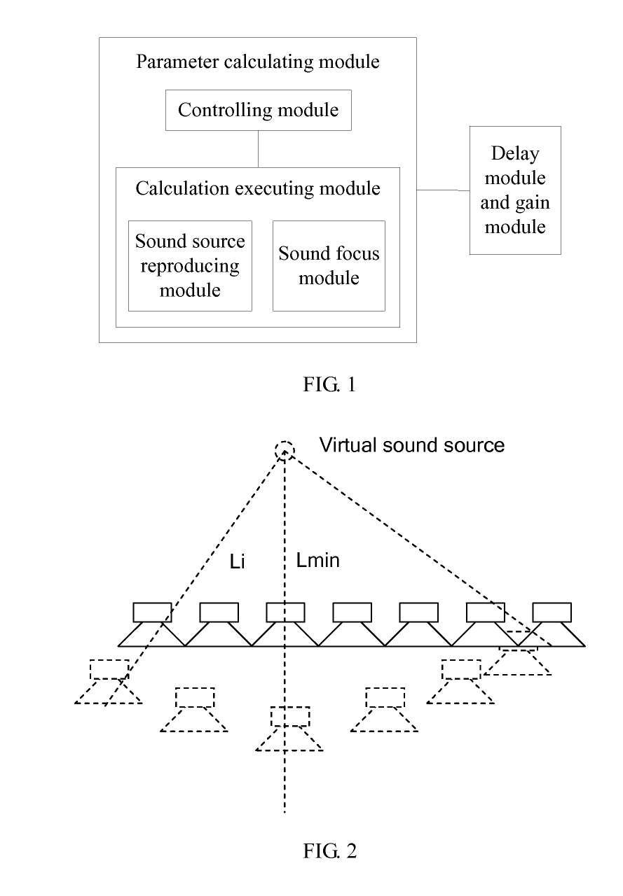

One embodiment of the present invention provides a loudspeaker array device. As shown in FIG. 1, the device includes a delay module, a gain module, and a parameter calculating module. The delay module and the gain module process audio signals according to delay parameters and gain parameters calculated by the parameter calculating module, and then output the processed audio signals. To implement the sound source reproduction and the sound focus, the parameter calculating module includes a controlling module and a calculation executing module.

The controlling module is configured to determine, according to the received user control information, the delay parameters and gain parameters that need to be calculated, and output a determination result. The sound source reproduction and the sound focus require different delay parameters and gain parameters. The delay parameters and gain parameters include a first delay parameter and a first gain parameter; or a second delay parameter and a second gain parameter; or a first delay parameter, a first gain parameter, a second delay parameter and a second gain parameter; the first delay parameter and the first gain parameter are configured to reproduce a sound source, the second delay parameter and the second gain parameter are configured to focus sounds. The user control information is generally preset or input by the user to control the loudspeaker array device to implement the sound source reproduction function or sound focus function.

The calculation executing module is configured to calculate and output the delay parameters and the gain parameters according to the received determination result output by the controlling module. When the controlling module determines that the first delay parameter and the first gain parameter need to be calculated, a sound source reproducing module in the calculation executing module calculates the first delay parameter and the first gain parameter according to the determination result output by the controlling module, the preset position information of the loudspeaker, and the preset or received azimuth of the audio signals, and then the sound source reproducing module outputs a calculation result. When the controlling module determines that the second delay parameter and the second gain parameter need to be calculated, a sound focus module in the calculation executing module calculates the second delay parameter and the second gain parameter according to the received determination result output by the controlling module, the preset position information of the loudspeaker, and the preset or received focus position information, and then the sound focus module outputs a calculation result. The position information of the loudspeaker may be preset before delivery of the loudspeaker device. For example, if the loudspeaker device is a linear loudspeaker array device, the position information includes the distance between loudspeakers and the number of loudspeakers. The azimuth information of the audio signals is generally provided together with the audio signals to the loudspeaker array device. The default focus position information is provided before delivery. For example, for a linear loudspeaker array, the default focus position is the front of the middle part, and after delivery, the focus position may be adjusted according to the user's actual position. That is, if the user is seated in left front of the loudspeaker array, the focus position may be adjusted to left front.

The delay module and the gain module process the audio signals according to the received delay parameters and gain parameters, and then output a processing result. The delay module and the gain module can output the processed audio signals to the loudspeaker by means of an amplifier. When the calculation executing module calculates the first delay parameter and the first gain parameter, the delay module and the gain module process the audio signals according to the received first delay parameter and first gain parameter. When the calculation executing module calculates the second delay parameter and the second gain parameter, the delay module and the gain module process the audio signals according to the received second delay parameter and second gain parameter. The delay module and the gain module may be integrated into one module or be two independent modules. In this manner, the connection sequence of the delay module and the gain module is not restricted. In the embodiments of the present invention, the gain module may be a filter, which implements the corresponding function by modifying the spectrum of the audio signals. In this manner, the delay module and the gain module calculate filter parameters.

It should be noted that the loudspeaker array illustrated in FIG. 1 may be an independent device or be integrated into another device, such as a set top box (STB). In this case, the functions of the modules illustrated in FIG. 1 may be implemented in the STB, and the loudspeakers can function as external devices and be connected with the STB.

FIG. 2 is a schematic diagram of calculating delay parameters in the implementation of sound source reproduction. As shown in FIG. 2, a virtual sound source which is to be virtualized is the farthest from the rightmost loudspeaker, but the distance from the loudspeakers represented by the dashed lines to the virtual sound source is the same as the distance from the rightmost loudspeaker to the virtual sound source, which means that these loudspeakers are on the same sphere. According to the Huyghen principle, when the rightmost loudspeaker outputs sounds, the sounds output by other loudspeakers represented by the real lines arrive at the positions of the loudspeakers represented by the dashed lines. That is, when the rightmost loudspeaker outputs sounds, all the sounds from the loudspeakers form a wave front. The wave front is the same as the wave front generated by the virtual sound source. Therefore, the audience may fall into the illusion that the sounds are emitted from the virtual sound source. Thereby the sound source is reproduced. It can be known from the preceding description that, the third loudspeaker (from left to right) as shown in FIG. 2 is closest to the virtual sound source, and therefore no delay is required. The second and fourth loudspeakers required certain delays and the rightmost loudspeaker has a longest delay. Assuming that Lₘᵢₙ is represented the shortest distance from the loudspeaker to the virtual sound source, and that Lᵢ is the distance from the i^{th} loudspeaker to the virtual sound source, the delay of the i^{th} loudspeaker is as follows

τᵢ=(Lᵢ−Lₘᵢₙ)/c where, c is the sonic velocity.

When the sound is transmitted in the air, its attenuation velocity is approximately in inverse proportion to the square of the transmission distance. Therefore, for the implementation of the sound source reproduction, the gain parameters of each loudspeaker need to be in inverse proportion to the square of the distance from the loudspeaker to the virtual sound source. Assuming gᵢ is the gain of the i^{th} loudspeaker, then

$${g}_{i} = \frac{G}{{L}_{i}^{2}} where ,$$

G is a constant.

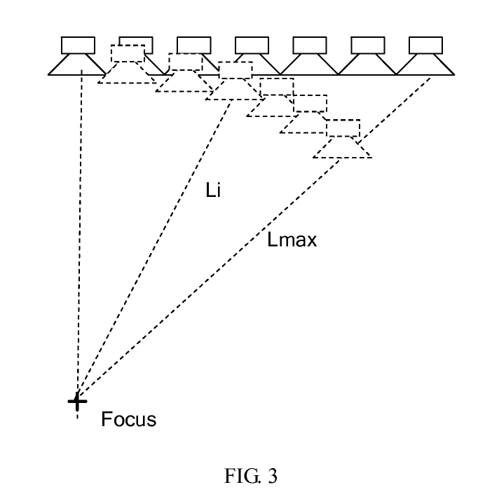

FIG. 3 is a schematic diagram of calculating delay parameter in the implementation of the sound focus. For the implementation of the sound focus, the sounds outputted from the loudspeakers need to arrive at a sphere simultaneously, where the center of the sphere is the focus. It can be seen that, because the virtual sound source is located behind the loudspeakers but the focus is in front of the loudspeakers, one of the formed spheres is convex and the other is concave. In FIG. 3, the focus needs to be closest to the leftmost loudspeaker. In this manner, when the leftmost loudspeaker outputs sounds, the sounds from all the loudspeakers arrive at the positions of the loudspeakers represented by the dashed lines, that is, the same sphere. The rightmost loudspeaker is farthest from the focus and therefore no delay is needed. The leftmost loudspeaker, however, has the longest delay. Assuming that Lₘₐₓ is the longest distance from the loudspeaker to the virtual sound source, and that Lᵢ is the distance from the i^{th} loudspeaker to the virtual sound source, the delay of the i^{th} loudspeaker is as follows

τᵢ=(Lₘₐₓ−Lᵢ)/c where, c is the sonic velocity.

For the implementation of the sound focus, the energy of the sounds outputted by each loudspeaker needs to be the same at the focus. Therefore, the gain parameters need to be in proportion to the square of the distance from the loudspeaker to the focus. Assuming gᵢ is the gain of the i^{th} loudspeaker, then

gᵢ=G*Lᵢ² where, G is a constant.

According to the embodiments of the present invention, a single sound source can be reproduced, or the sounds from a single sound source can be focused to one or multiple positions. According to the embodiments of the present invention, multiple sound sources can be reproduced or sounds can be focused to multiple positions. The following embodiments describe the sound source reproduction and the sound focus in detail.

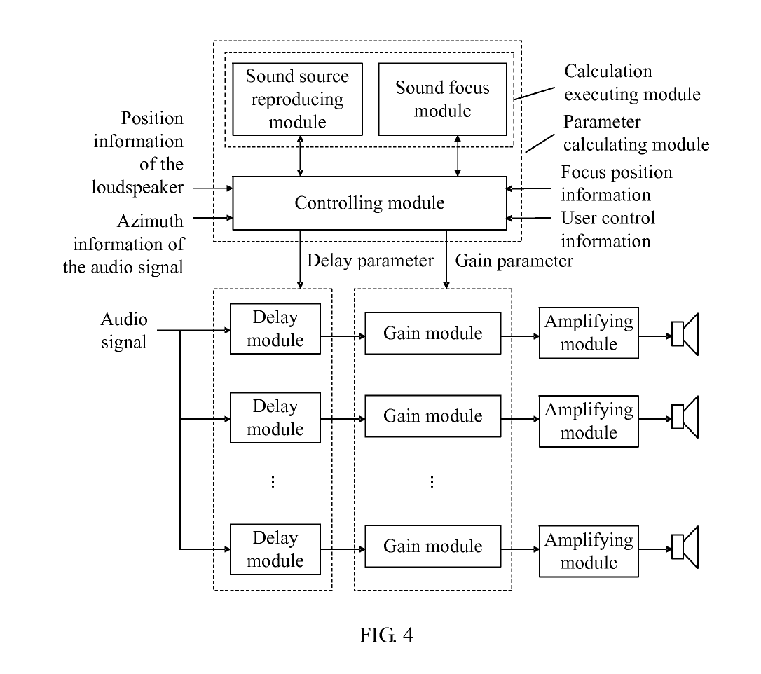

The structure of a loudspeaker array device according to another embodiment of the present invention is illustrated in FIG. 4, including the modules described in the previous embodiment. As shown in FIG. 4, a single audio signal is processed by each delay module and gain module, and is then sent to each loudspeaker by means of the amplifier.

When the user control information received by the controlling module indicates that a single sound source needs to be reproduced, the sound source reproducing module in the calculation executing module calculates the delay parameters and the gain parameters of each loudspeaker, and outputs the parameters to the corresponding loudspeaker. For example, for loudspeaker 1, delay parameter 1 and gain parameter 1 of loudspeaker 1 are calculated according to the position information of loudspeaker 1 and the azimuth of the audio signals, and the delay parameter 1 and gain parameter 1 are then output to delay module 1 and gain module 1 respectively, where the delay module 1 and gain module 1 are connected to the loudspeaker 1. Likewise, for loudspeaker n, delay parameter n and gain parameter n of loudspeaker n are calculated according to the position information of loudspeaker n and the azimuth of the audio signals, and the delay parameter n and gain parameter n are then output to delay module n and gain module n respectively, where the delay module n and gain module n are connected to the loudspeaker n. Each delay parameter and each gain parameter can also be calculated separately by a sound source reproducing module, and then the parameters are output to the delay module and the gain module that correspond to each loudspeaker. In this manner, according to the principle of FIG. 2, the sounds coming from each loudspeaker form a virtual sound source. When listening to the sounds coming from the loudspeakers, the user may feel that the sounds come from the virtual sound source.

When the user control information received by the controlling module indicates that the sound from a single sound source needs to be focused to one position, the sound focus module in the calculation executing module calculates the delay parameters and the gain parameters of each loudspeaker, and outputs the parameters to the corresponding loudspeaker. For example, for loudspeaker 1, delay parameter 1 and gain parameter 1 of loudspeaker 1 are calculated according to the position information of loudspeaker 1 and the focus position information, and the delay parameter 1 and gain parameter 1 are then outputted to the delay module 1 and gain module 1 respectively, where the delay module 1 and gain module 1 are connected to the loudspeaker 1. Likewise, for loudspeaker n, delay parameter n and gain parameter n of loudspeaker n are calculated according to the position information of loudspeaker n and the focus position information, and the delay parameter n and gain parameter n are then output to delay module n and gain module n respectively, where the delay module n and gain module n are connected to the loudspeaker n. Each delay parameter and gain parameter can also be calculated separately by a sound focus module, and then a calculation result is output to the delay module and the gain module corresponding to each loudspeaker. In this manner, according to the principle of FIG. 3, the sounds output from each loudspeaker are focused at the preset position.

According to the embodiments of the present invention, a single sound source can be reproduced, or the sounds from a single sound source can be focused to one or multiple positions.

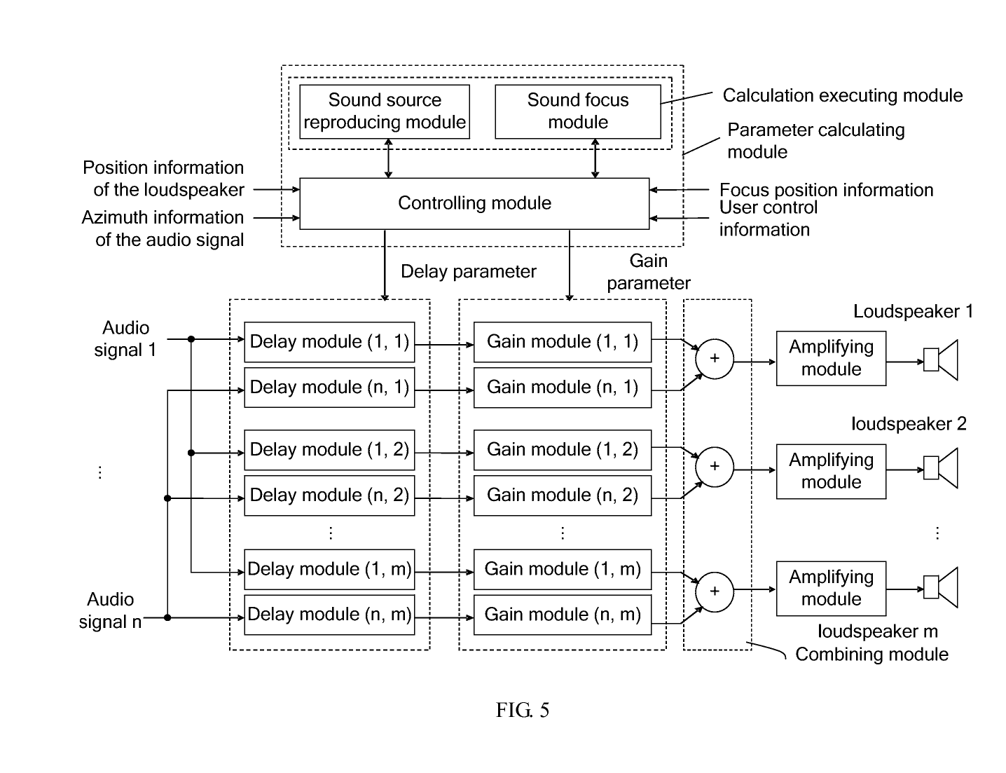

The structure of a loudspeaker array device according to another embodiment of the present invention is illustrated in FIG. 5, where multiple audio signals are involved.

As shown in FIG. 5, there are multiple audio signals. The multiple audio signals can be the same signals or different signals. The delay module and the gain module corresponding to the added audio signals are provided. For example, for the first added audio signal, namely audio signal 2, a group of delay modules and a group of gain modules are provided. In addition to the amplifying module, a group of combining modules is provided.

As shown in FIG. 5, if there are n audio signals and m loudspeakers, there are n×m delay modules and n×m gain modules. Each delay module and each gain module are identified with identifiers, for example, delay module (i, j), gain module (i, j), where i=1, 2, . . . , n (corresponding to the number of each audio signal), and j=1, 2, . . . , m (corresponding to the number of each loudspeaker). Each audio signal is input into the corresponding delay module, processed by the delay module, and then input into the corresponding gain module for processing. For example, audio signal 2 is input into delay module (2, 1), delay module (2, 2), . . . , delay module (2, m), processed by these delay modules, and then input into gain module (2, 1), gain module (2, 2), . . . , gain module (2, m) for processing. After the signals processed by the gain modules are combined by the combining module, the combined signals are amplified by an amplifying module, and then input into the corresponding loudspeaker. For example, the signals from gain module (1, 1), gain module (2, 1), . . . , gain module (n, 1) are input to a combining module and combined into one signal by the combining module, and the combined signal is amplified by the amplifying module and then input into loudspeaker 1. One simple implementation mode of the combining module is to add the signals input to the combining module.

The controlling module in the parameter calculating module can reproduce multiple sound sources according to the user control information, and can also focus sounds to multiple positions. In addition, the sound source reproduction and sound focus can be implemented concurrently.

When determining to reproduce multiple sound sources, the controlling module invokes the sound source reproducing module in the calculation executing module, according to the azimuth of each audio signal contained in the azimuth information of the audio signals and the position information of each loudspeaker, to calculate the delay parameters and the gain parameters of each audio signal, and then send the parameters to the delay module and the gain module. For example, if there are audio signal 1 and audio signal 2, and m loudspeakers, the controlling module invokes the sound source reproducing module, according to the azimuth information of audio signal 1 and the position information of each loudspeaker, to calculate m delay parameters and m gain parameters, identified as T (1, 1), T (1, 2), . . . , T (1, m), and G (1, 1), G (1, 2), . . . , G (1, m); similarly, the controlling module invokes the sound source reproducing module, according to the azimuth information of audio signal 2 and the position information of each loudspeaker, to calculate m delay parameters and m gain parameters, identified as T (2, 1), T (2, 2), . . . , T (2, m), and G (2, 1), G (2, 2), . . . , G (2, m). After the parameters are calculated, the controlling module sends the delay parameters and the gain parameters to the corresponding delay modules and gain modules. That is, T (1, 1) is sent to delay module (1, 1), and G (1, 1) is sent to gain module (1, 1); T (1, 2) is sent to delay module (1, 2), and G (1, 2) is sent to gain module (1, 2); . . . , T (2, m) is sent to delay module (2, m), and G (2, m) is sent to gain module (2, m).

When determining to focus sounds to multiple positions, the controlling module invokes the sound focus module in the calculation executing module, according to the position information of multiple focuses contained in the focus position information and the position information of each loudspeaker, to calculate the delay parameters and the gain parameters corresponding to each focus, and then send the parameters to the delay module and the gain module. For example, if there are focus 1 and focus 2, and m loudspeakers, the controlling module invokes the sound focus module, according to the position information of focus 1 and the position information of each loudspeaker, to calculate m delay parameters and m gain parameters, identified as T′ (1, 1), T′ (1, 2), . . . , T′ (1, m), and G′ (1, 1), G′ (1, 2), . . . , G′ (1, m); similarly, the controlling module invokes the sound focus module, according to the position information of focus 2 and the position information of each loudspeaker, to calculate m delay parameters and m gain parameters, identified as T′ (2, 1), T′ (2, 2), . . . , T′ (2, m), and G′ (2, 1), G′ (2, 2), . . . , G′ (2, m). After the parameters are calculated, the controlling module sends the delay parameters and the gain parameters to the corresponding delay modules and gain modules. That is, T′ (1, 1) is sent to delay module (1, 1), and G′ (1, 1) is sent to gain module (1, 1); T′ (1, 2) is sent to delay module (1, 2), and G′ (1, 2) is sent to gain module (1, 2); . . . , T′ (2, m) is sent to delay module (2, m), and G′ (2, m) is sent to gain module (2, m).

According to the embodiments of the present invention, multiple sound sources can be reproduced or sounds can be focused to multiple positions.

The principle of the sound source reproduction is reverse to that of the sound focus. If the sound source reproduction and sound focus need to be implemented concurrently, they can be approximate to some extent. Embodiments of the present invention provide a technical solution to concurrent sound source reproduction and sound focus. For example, in the case of a stereo dual-channel sound source, the stereo includes two channels. In order that the sounds from the left/right channel can be heard at only a certain position and that the sound source can be reproduced at the same time, the loudspeakers at a predetermined first position in the loudspeaker array can be used to output the left-channel audio signals (the left loudspeakers are used to output the left-channel audio signals); and the loudspeakers at a predetermined second position in the loudspeaker array can be used to output the right-channel audio signals (the right loudspeakers are used to output the right-channel audio signals). The left-channel and right-channel audio signals are focused to the same position. The specific positions of the loudspeakers may be determined according to the actual requirement of the sound source reproduction. The details are as follows. For the left-channel audio signals, the parameter calculating module calculates, according to the focus position information and the position information of the left loudspeakers (1 to m/2), the delay parameters and the gain parameters of the left loudspeakers, where the delay parameters are identified as T″ (1, 1), T″ (1,2), . . . , T″ (1, m/2), and the gain parameters are identified as G″ (1, 1), G″ (1, 2), . . . , G″ (1, m/2). For the right-channel audio signals, the parameter calculating module calculates, according to the focus position information and the position information of the right loudspeakers (m to m/2+1), the delay parameters and the gain parameters of the right loudspeakers, where the delay parameters are identified as T″ (2, m/2+1), T″ (2, m/2+2), . . . , T″ (2, m), and the gain parameters are identified as G″ (2, m/2+1), G″ (2, m/2+2), . . . , G″ (2, m). After the parameters are calculated, the parameter calculating module sends the delay parameters and the gain parameters to the corresponding delay module and the corresponding gain module respectively. That is, the parameter calculating module sends T″ (1, 1) to delay module (1, 1), and G″ (1, 1) to gain module (1, 1) . . . ; sends T″ (1, m/2) to delay module (1, m/2), and G″ (1, m/2) to gain module (1, m/2); sends T″ (2, m/2+1) to delay module (2, m/2+1), G″ (2, m/2+1) to gain module (2, m/2+1); . . . ; and sends T″ (2, m) to delay module (2, m), and G″(2, m) to gain module (2, m). When the audio signals are sent to the delay modules, the left-channel audio signals are only sent to delay module (1, 1), delay module (1, 2), . . . , delay module (1, m/2), and the right-channel audio signals are only sent to delay module (2, m/2+1), delay module (2, m/2+2), . . . , delay module (2,m). In this manner, the embodiments of the present invention implement the sound source reproduction and the sound focus.

In embodiments of the present invention, multiple parameter calculating modules can be used to calculate the delay parameter and the gain parameter of each audio signal; or one parameter calculating module is used to calculate the delay parameters and the gain parameters of all the audio signals. This reduces costs.

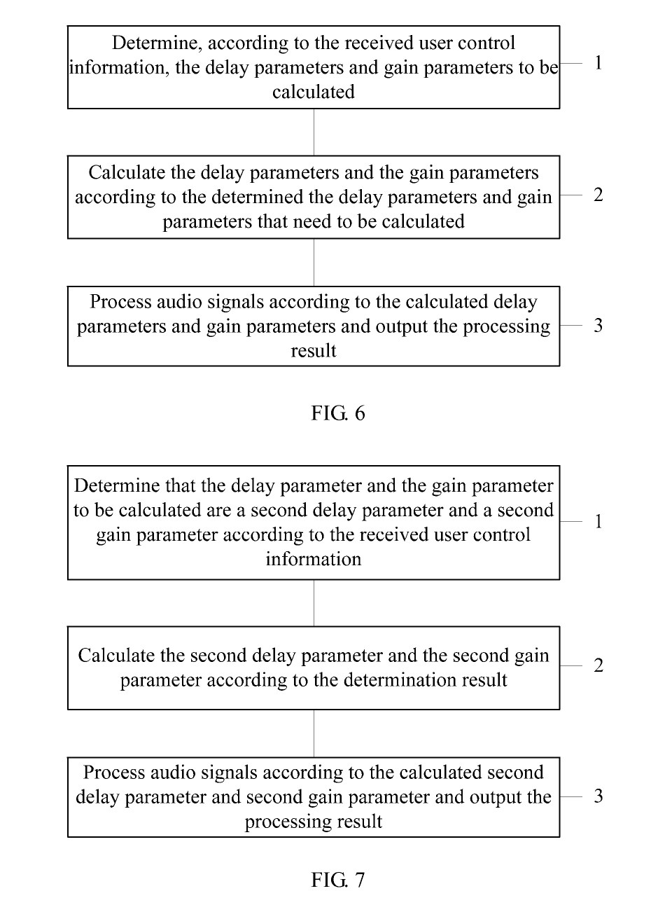

A method for driving a loudspeaker array according to one embodiment of the present invention includes the following steps, as shown in FIG. 6.

Step 1: Determine the types of delay parameters and gain parameters that need to be calculated according to the received user control information. The parameters include a first delay parameter and a first gain parameter, or a second delay parameter and a second gain parameter; or a first delay parameter, a first gain parameter, a second delay parameter and a second gain parameter. The first delay parameter and the first gain parameter are used to reproduce a sound source, the second delay parameter and the second gain parameter are used to focus the sounds of loudspeakers. The controlling module in the loudspeaker array device determines the delay parameters and gain parameters that need to be calculated.

Step 2: Calculate the delay parameters and gain parameters according to the determined types of delay parameters and gain parameters that need to be calculated. Specifically, the calculation executing module calculates the delay parameters and gain parameters.

Step 3: According to the calculated delay parameters and gain parameters, process the audio signals and then output a calculation result. Specifically, the audio signals can be processed by the delay module and the gain module.

If the determined parameters that need to be calculated in step 1 are the first delay parameter and the first gain parameter, in step 2, the sound source reproducing module in the calculation executing module calculates the first delay parameter and the first gain parameter according to the preset loudspeaker position information, and the preset or received azimuth information of the audio signals.

If the determined parameters that need to be calculated in step 1 are the second delay parameter and the second gain parameter, in step 2, the sound focus module in the calculation executing module calculates the second delay parameter and the second gain parameter according to the preset loudspeaker position information, and the preset or received focus position information.

In the embodiment of the present invention, the processing result output in step 3 can be amplified, and the processed information is output to the corresponding loudspeaker. Specifically, the amplifying module processes the output information.

According to the embodiments of the present invention, a single sound source can be reproduced, and the sounds from a single sound source can be focused to one or multiple positions. The implementation is simple, convenient, and cost effective. If multiple sound sources need to be reproduced or sounds need to be focused to multiple positions, the operations described in the embodiments of the present invention only need to be performed for each sound source.

Another embodiment of the present invention provides a method for sound focus. The flowchart of the method is shown in FIG. 7, including the following steps.

Step 1: According to the received user control information, determine that the types of delay parameters and gain parameters that need to be calculated are the second delay parameter and the second gain parameter. To be specific, the types of parameters are determined by the controlling module in the loudspeaker array device.

Step 2: According to the determined parameters to be calculated, calculate the second delay parameter and the second gain parameter. Specifically, the second delay parameter and the second gain parameter are calculated by the calculation executing module

Step 3: According to the calculated second delay parameter and second gain parameter, process the audio signals and output a processing result. Specifically, the audio signals can be processed by the delay module and the gain module. The loudspeakers at the first predetermined position in the loudspeaker array output left-channel signals, and the loudspeakers at the second predetermined position in the loudspeaker array output right-channel signals. The signals on these two channels are focused to the same position. For example, the loudspeakers at the first predetermined position may be the left loudspeakers (for the audience, the left loudspeakers in the loudspeaker array), and the loudspeakers at the second predetermined position may be the right loudspeakers (for the audience, the right loudspeakers in the loudspeaker array). In this manner, the embodiments of the present invention implement the sound source reproduction and the sound focus concurrently. The implementation is simple, convenient, and cost effective.

In conclusion, the above are merely exemplary embodiments of the present invention. The scope of the present invention is not limited thereto. Variations or replacements readily apparent to persons skilled in the prior art within the technical scope of the present invention should fall within the scope of the present invention. Therefore, the scope of the present invention is defined by the appended claims.

1. A loudspeaker array device, comprising:
a parameter calculating module, wherein the parameter calculating module comprises:
a controlling module, configured to determine, according to received user control information, types of delay parameters and gain parameters that need to be calculated, and output a determination result, wherein the delay parameters and gain parameters comprise a first delay parameter and a first gain parameter used to reproduce a sound source, and/or a second delay parameter and a second gain parameter used to focus sounds; and
a calculation executing module, configured to calculate and output the delay parameters and the gain parameters according to the determination result output by the controlling module;
a delay module that is configured to process and output audio signals according to the received delay parameters; and
a gain module that is configured to process and output audio signals according to the received gain parameters.

2. The device according to claim 1, wherein the calculation executing module comprises a sound source reproducing module, configured to calculate the first delay parameter and the first gain parameter according to the received determination result output by the controlling module, preset loudspeaker position information, and preset or received azimuth information of the audio signals, and output a calculation result.

3. The device according to claim 1, further comprising:
an amplifying module, configured to amplify and output the audio signals processed and output by the delay module and the gain module.

4. The device according to claim 2, further comprising:
an amplifying module, configured to amplify and output the audio signals processed and output by the delay module and the gain module.

5. A method for driving a loudspeaker array device, the method comprising:
determining, according to received user control information, types of delay parameters and gain parameters that need to be calculated, wherein delay parameters and gain parameters comprise: a first delay parameter and a first gain parameter used to reproduce a sound source, and/or a second delay parameter and a second gain parameter used to focus sounds;
calculating values for the delay parameters and the gain parameters according to the determined types of the delay parameters and gain parameters that need to be calculated; and
processing and outputting audio signals according to the calculated values of the delay parameters and the gain parameters.

6. The method according to claim 5, wherein calculating the delay parameters and the gain parameters comprises calculating the first delay parameter and the first gain parameter according to preset loudspeaker position information and preset or received azimuth information of the audio signals.

7. The method according to claim 5, further comprising:
amplifying the information output after audio signal processing according to the received delay parameters and the gain parameters and outputting the processed information.

8. The method according to claim 6, further comprising:
amplifying the information output after audio signal processing according to the received delay parameters and the gain parameters and outputting the processed information.

9. The method according to claim 5, wherein:
the delay parameter and the gain parameter that need to be calculated are the second delay parameter and the second gain parameter respectively;
the calculated values of the delay parameter and the gain parameter are calculated values of the second delay parameter and the second gain parameter respectively; and
processing the audio signals according to the calculated delay parameters and gain parameters comprises: processing the audio signals according to the second delay parameter and the second gain parameter, enabling loudspeakers at a first predetermined position in the loudspeaker array to output left-channel signals and enabling loudspeakers at a second predetermined position to output right-channel signals, and focusing the left-channel and right-channel signals to a same position.

10. The method according to claim 6, wherein calculating the delay parameters and the gain parameters further comprises calculating the second delay parameter and the second gain parameter according the preset loudspeaker position information and preset or received focus position information.

11. The method according to claim 5, wherein calculating the delay parameters and the gain parameters comprises calculating the second delay parameter and the second gain parameter according the preset loudspeaker position information and preset or received focus position information.

12. The method according to claim 11, further comprising:
amplifying the information output after audio signal processing according to the received delay parameters and the gain parameters and outputting the processed information.

13. The device according to claim 2, wherein the calculation executing module further comprises a sound focus module, configured to calculate the second delay parameter and the second gain parameter according to the received determination result output by the controlling module, the preset loudspeaker position information, and preset or received focus position information, and output a calculation result.

14. The device according to claim 1, wherein the calculation executing module comprises a sound focus module, configured to calculate the second delay parameter and the second gain parameter according to the received determination result output by the controlling module, the preset loudspeaker position information, and preset or received focus position information, and output a calculation result.

15. The device according to claim 14, further comprising:
an amplifying module, configured to amplify and output the audio signals processed and output by the delay module and the gain module.

16. The device according to claim 1, wherein the delay parameters and gain parameters comprise the first delay parameter and the first gain parameter but not the second delay parameter or the second gain parameter.

17. The device according to claim 1, wherein the delay parameters and gain parameters comprise the second delay parameter and the second gain parameter but not the first delay parameter or the first gain parameter.

18. The device according to claim 1, wherein the delay parameters and gain parameters comprise the first delay parameter, the first gain parameter, the second delay parameter and the second gain parameter.
